(19) United States
(12) Patent Application Publication
(10) Pub. No.: US 2026/0195540 A1
(43) Pub. Date: Jul. 9, 2026

(54) SEMANTIC CHANGE DETECTION SYSTEM

(71) Applicant: Hitachi, Ltd., Tokyo (JP)

(72) Inventors: Takashi TAMESHIGE, Tokyo (JP); Taku WAKUI, Tokyo (JP)

(21) Appl. No.: 19/311,327

(22) Filed: Aug. 27, 2025

(30) Foreign Application Priority Data
Jan. 9, 2025 (JP) 2025-003500

(51) Int. Cl. G06F 40/30; G06F 40/40

(52) U.S. Cl. CPC G06F 40/30; G06F 40/40

(57) ABSTRACT

A semantic change detection system according to the present invention includes: an update acquisition unit adapted to acquire the updated portion; a first processing unit adapted to detect whether the updated portion acquired by the update acquisition unit includes a semantic change and, further, adapted to present, to a user, that the updated portion includes the semantic change when it detects that the updated portion includes the semantic change; and a second processing unit, the second processing unit being adapted to detect whether or not the updated portion not having been detected to include the semantic change by the first processing unit includes the semantic change at a meta-information level, by generating meta information using domain knowledge relating to the service system, the second processing unit further being adapted to present, to the user, a result of the detection for the updated portion.

### CROSS-REFERENCE TO RELATED APPLICATION

The present application claims priority to Japanese Patent Application No. 2025-003500, filed Jan. 9, 2025. The contents of this application are incorporated herein by reference in their entirety.

### BACKGROUND OF THE INVENTION

### 1. Field of the Invention

The present invention relates to a semantic change detection system.

### 2. Description of the Related Art

In recent years, due to rapid development of digital technologies, many companies have been utilizing some IT services including cloud. Such IT services generally necessitate large costs for maintenance thereof and, therefore, an increasing number of companies have tended to promote automation and autonomy of IT operations (IT Operations).

Meanwhile, at sites of IT operations, there are “tasks which can be carried out only by persons”, depending on individual situations or targeted IT systems.

One of such tasks is an event operation. Such an event operation is one type of a monitoring task for an IT system, which is a basic task for an IT operation. As such an event operation, an operator checks an abnormal event, out of a huge number of events transmitted from a business application or the like to an event monitoring server, and performs an answering task with reference to a handling instruction sheet. Such an event operation is a typical “task which can be carried out only by a person”, because no rule is established for finding an appropriate handling instruction sheet according to the content of an abnormal event, handling instruction sheets describe ambiguous definitions therein, and for other reasons. Furthermore, in such an event operation, when an update has been performed on a document such as a manual which supports a handling instruction sheet, it is difficult to automate determination as to whether this update is, for example, a substantial change in content or a mere formal correction, since the document itself is described in a natural language.

For coping therewith, JP 2000-207184 A discloses a technique regarding automation of a system operation at a program development site. In JP 2000-207184 A, even if an update is performed on a program source shared among a plurality of projects, a semantic connection is detected therein through a specific description in the program source and, for example, a line feed code is inserted into the program source, in order to improve readability.

### SUMMARY OF THE INVENTION

However, the technique disclosed in JP 2000-207184 A is targeted to a programming language, and the detection of an update is based on the premise that a specific technique (for example, a common syntax statement) is manually predefined. Namely, this technique is an effective means in cases of restricted grammars such as program sources, and is not applicable to document updates as described above.

Therefore, an object of the present invention is to provide a technique for detecting the presence or absence of a semantic change when an update has been performed on a document such as a manual described in a natural language.

In order to overcome the aforementioned problems, one of representative semantic change detection systems according to the present invention includes: an update acquisition unit adapted to acquire the updated portion; a first processing unit, the first processing unit being adapted to detect whether the updated portion acquired by the update acquisition unit includes a semantic change, the first processing unit being further adapted to present, to a user, that the updated portion includes the semantic change when the first processing unit detects that the updated portion includes the semantic change; and a second processing unit, the second processing unit being adapted to detect whether or not the updated portion not having been detected to include the semantic change by the first processing unit includes the semantic change at a meta-information level, by generating meta information using domain knowledge relating to a system, the second processing unit further being adapted to present, to the user, a result of the detection for the updated portion.

According to the present invention, it is possible to provide a technique which enables detecting the presence or absence of a semantic change in a document described in a natural language.

### BRIEF DESCRIPTION OF THE DRAWINGS

FIG. 1 is a diagram illustrating an example of the structure of a computer machine system according to a present embodiment;

FIG. 2 is a diagram illustrating an example of the structure of a management system according to the present embodiment;

FIG. 3 is a diagram illustrating an example of the structure of a management target server according to the present embodiment;

FIG. 4 is a diagram illustrating a general outline of processes in a semantic change detection system according to the present embodiment;

FIG. 5 is a diagram illustrating an example of a document management table according to the present embodiment;

FIG. 6 is a diagram illustrating an example of a semantic change condition management table according to the present embodiment;

FIG. 7 is a diagram illustrating an example of a change content management table according to the present embodiment; and

FIG. 8 is a diagram illustrating an example of processes of a change content determination program according to the present embodiment.

### DESCRIPTION OF THE PREFERRED EMBODIMENTS

Hereinafter, an embodiment of the present invention will be described with reference to the drawings. Note that the present invention is not limited by this embodiment. In addition, in the description of the drawings, the same portions are denoted by the same reference characters.

### General Outline of the Present Embodiment

In the present embodiment, a semantic change detection system for detecting the presence or absence of a semantic change in an update will be described, by exemplifying an update of a document (for example, a manual) stored in a document repository. Here, the presence or absence of a semantic change in an update refers to the presence or absence of an influence on a handling instruction sheet which is created based on the document and is to be referred to by an operator when the operator gives an answer, for example. In a case where it is assumed that the handling instruction sheet is substantively changed due to an update of the document, and the contents of tasks of the operator are changed, this update is determined to “include a semantic change”. In a case where it is not assumed so, this update is determined to “include no semantic change”.

Namely, when a developer has changed the structure of a system including software, the developer usually updates a document relating thereto, such as a manual.

On the other hand, a higher-position administrator is responsible for managing and updating the handling instruction sheet, which is to be referred to by the operator in event operations. When the document has been updated, the higher-position administrator is required to determine whether or not to change the substance of the handling instruction sheet. The semantic change detection system according to the present embodiment determines whether or not such an update of the document by the developer involves a semantic change which necessitates changing the substance of the handling instruction sheet. Further, the semantic change detection system presents the result thereof to the higher-position administrator.

For example, when an update of the document can be addressed only by character string replacement, such as in a case of a type mistake, this update does not involve a semantic change, and is addressed by character string replacement in sentences and words in the handling instruction sheet. On the other hand, when an update of the document is associated with a specification change of an application programmable interface (API), it is highly likely that this update can not be addressed merely by character string replacement and involves a semantic change. The higher-position administrator needs to determine the necessity of a redesign or an operation test, depending on the content of the update of the document. At that time, the semantic change detection system according to the present embodiment can present a result of simple analysis of the content of the update, which enables the higher-position administrator to easily and quickly determine the necessity thereof.

Conventionally, it has been possible to grasp the timing that a developer has updated a document. However, in order to obtain a basis for determining which part of a handling instruction sheet to change or how to change it according to the update of the document or for determining that there is no need for changing the handling instruction sheet, a higher-position administrator needs not only to grasp the timing of update of the document but also to know the presence or absence of a semantic change therein. This has required the higher-position administrator to have knowledge and experience and, further, to take time and effort.

According to the semantic change detection system according to the present embodiment, it is possible to easily determine whether or not a handling instruction sheet needs to be changed, and it is possible to reduce the cost therefor.

### Description of Terms

In the present disclosure, an “interface unit” includes one or more interfaces. The one or more interfaces may be one or more interface devices of the same type (for example, one or more network interface cards (NIC)) or two or more interface devices of different types (for example, an NIC and a host bus adapter (HBA)).

In the present disclosure, a “storage unit” includes one or more memories. The at least one memory may be a volatile memory or a nonvolatile memory. The storage unit may include one or more HDs, in addition to the one or more memories. The “HD” means a physical storage device, and may typically be a non-volatile storage device (for example, an auxiliary storage device). The HDs may be, for example, hard disk drives (HDD) or solid state drives (SSD).

In the present disclosure, a “processor unit” includes one or more processors. The at least one processor is typically a central processing unit (CPU). The processor may include a hardware circuit that performs portions or all of processes.

Furthermore, in the present disclosure, processes may be described using the term “program” as a subject, in some cases. However, the program is executed by the processor unit, thereby performing predetermined processes appropriately using at least one of the storage unit and the interface unit and, therefore, the subject of the processes may be the processor unit (or a computer machine or a computer system including the processor unit). The program may be installed into a computer machine from a program source. The program source may be, for example, a program distribution server or a storage medium readable by a computer machine. In the following description, two or more programs may be realized as one program, or one program may be realized as two or more programs.

Furthermore, in the present disclosure, information may be described by being expressed as “xxx table”, but such information may be expressed as any data structure. Namely, in order to indicate that information does not depend on the data structure, “xxx table” can be referred to as “xxx information”. In the following description, the structure of each table is merely an example, and one table may be divided into two or more tables, or all or portions of two or more tables may be one table.

Further, in the present disclosure, an aggregation of one or more computer machines for displaying information to be displayed may be referred to as a “management system”. In a case where a management computer machine displays information on a display device in the management computer machine, the management computer machine may be a management system. Also, a combination of a management computer machine and a displaying computer machine may be a management system. Furthermore, a plurality of computer machines may implement processes equivalent to those of a management computer machine, in order to increase the speed and reliability of management processes. In this case, these plurality of computer machines (including a displaying computer machine, in a case where the displaying computer machine performs displaying) may be a management system. The term “displaying information to be displayed” by the management computer machine may mean displaying the information to be displayed on a display device included in the management computer machine, or transmitting the information to be displayed to a remote displaying computer machine by the management computer machine.

Further, in the present disclosure, when elements of the same type are described without being distinguished from each other, a reference numeral for the elements may be used. When elements of the same type are described in such a way as to be distinguished from each other, identification information allocated to the respective elements may be used. For example, when servers are described without being particularly distinguished from each other, the servers may be referred to as management target servers 102. When the individual servers are described in such a way as to be distinguished from each other, the servers may be referred to as a server #1 and a server #2.

### Structure

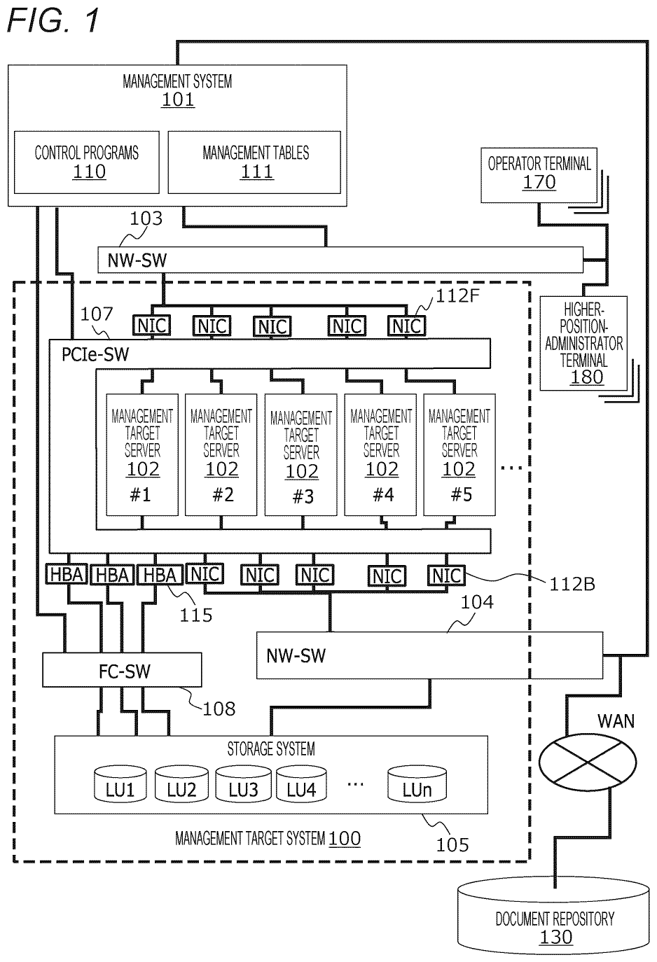

FIG. 1 is a diagram illustrating an example of the structure of a computer machine system according to the present embodiment.

The computer machine system includes, as main components, a management system 101, a management target system 100, a document repository 130, a higher-position-administrator terminal 180, and an operator terminal 170. In the computer machine system, a management network, a business network, and an I/O network, which will be described later, may be integrated.

The management system 101 is one or more computer machines. The management system 101 includes control programs 110 and management tables 111, and constitutes at least a part of the semantic change detection system according to the present embodiment. The management system 101 is connected to a NW-SW 103 and a NW-SW 104. Here, the NW-SW 103 is a network switch for enabling the management system 101 to distribute an operating system (OS) or an application to be implemented by a plurality of management target servers 102 and to perform operation management such as power supply control. The NW-SW 104 is a network switch used by an application executed in the management target servers 102. The NW-SW 104 is connected to a wide area network (WAN) or the like to communicate with a client computer machine in a server system.

The management system 101 can set a virtual local area network (VLAN) in each of the NW-SWs 103 and 104.

The management system 101 is also connected to a fiber channel switch (FC-SW) 108. The FC-SW 108 is an example of an input/output (I/O) network. The management system 101 is connected to a storage system 105 through the FC-SW 108.

The management target system 100 is one or more computer machines and is an IT system for providing business operations. In the present embodiment, the management target system 100 includes, as main components, a server system 107 including the plurality of management target servers (physical servers) 102, and the storage system 105 for providing a plurality of logical units (LUs), for example. Each of a plurality of servers 120 included in the storage system is to be monitored for event operations.

In the management target system 100, each of the management target servers 102 can execute a virtual machine (VM), as will be described later. The plurality of management target servers 102 are connected to the NW-SW 103 through a PCI-Express (PCIe)-SW 107 and a plurality of network interface cards (NICs) 112F, connected to the NW-SW 104 through the PCIe-SW 107 and a plurality of NICs 112B, and connected to the FC-SW 108 through the PCI-Express (PCIe)-SW 107 and a plurality of host bus adapters (HBAs). The NICs and the HBAs are examples of I/O devices.

The higher-position-administrator terminal 180 is one or more information processing terminals (for example, personal computers) which are handled by the higher-position administrator. In the present embodiment, the higher-position administrator is a member of at least one design team or operation management team.

The operator terminal 170 is one or more information processing terminals (for example, personal computers) which are handled by an operator. In the present embodiment, the operator is a member of at least one maintenance team, and performs event operations (such as monitoring of the service system and collection of information), based on a handling instruction sheet provided by the higher-position administrator who belongs to the design team or the operation management team.

The operator terminal 170 and the higher-position-administrator terminal 180 include a display unit, an input unit, a processor unit, and a storage unit, and execute programs with the processor unit, for example, to enable the management system 101 to perform inputting to the input unit and displaying on the display unit. The inputting/outputting functions of the operator terminal 170 and the higher-position-administrator terminal 180 may be referred to as user interfaces (UI).

The document repository 130 manages documents with a version management program such as Git. As the version management program, it is possible to use github.com or other services, or it is also possible to use a repository service (which may be a repository provided by a servicer or constructed by an own server) for storing deliverables such as container images, setting files, and documents. Further, the document repository 130 is constituted by one or more document repositories, and each document repository may be disposed anywhere inside and outside the WAN. Documents such as manuals for hardware and software used in the service system are stored in at least one document repository 130, and are updated and maintained/managed by a developer of the hardware and the software.

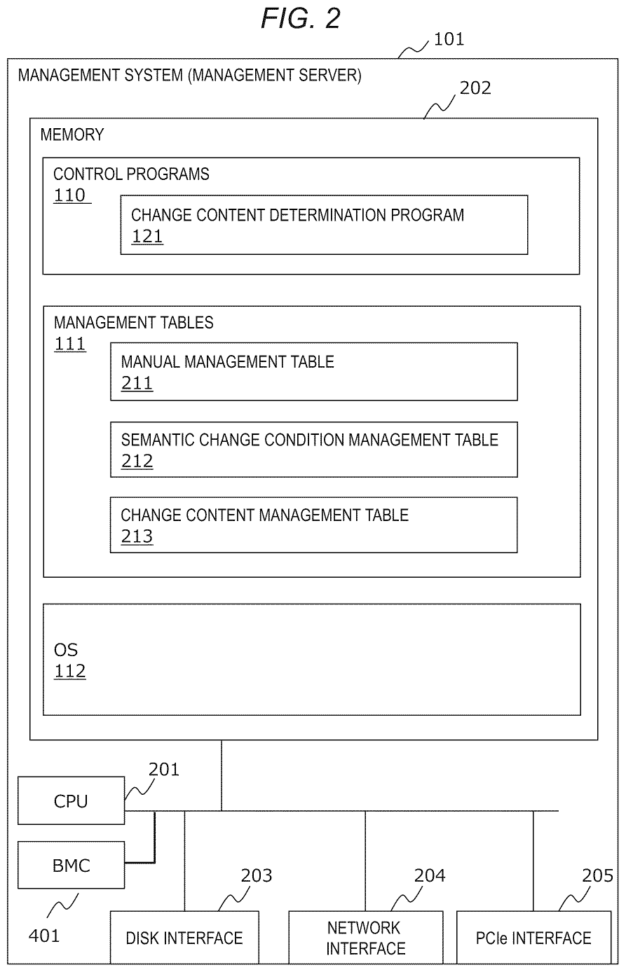

FIG. 2 is a diagram illustrating an example of the structure of the management system according to the present embodiment.

The management system 101 is a computer machine (server), for example, and includes an interface unit, a storage unit, and a processor unit connected to them.

The interface unit is, for example, a disk interface 203 for accessing the storage system 105, a network interface 204 for communication through the NW-SWs 103 and 104, and a PCIe interface 205 for communication through the PCIe-SW 107.

The processor unit is, for example, a CPU 201.

The storage unit is, for example, a memory 202. The memory 202 stores control programs 110, an OS 112, and management tables 111.

The control programs 110 include a change content determination program 121. The change content determination program 121 and the OS 112 are executed by the CPU 201.

The management tables 111 include a document management table 211, a semantic change condition management table 212, and a change content management table 213.

In one example, information registered in the management tables 111 may be information (raw information) collected by the change content determination program 121. Also, the information registered in the management tables 111 may be information resulted from processing the information, or may be information inputted through a console (not illustrated) in the management system 101 by the higher-position administrator or the operator. At least a part of the management tables 111 may be stored in a storage device (not illustrated) other than the memory 202 or in the storage system 105.

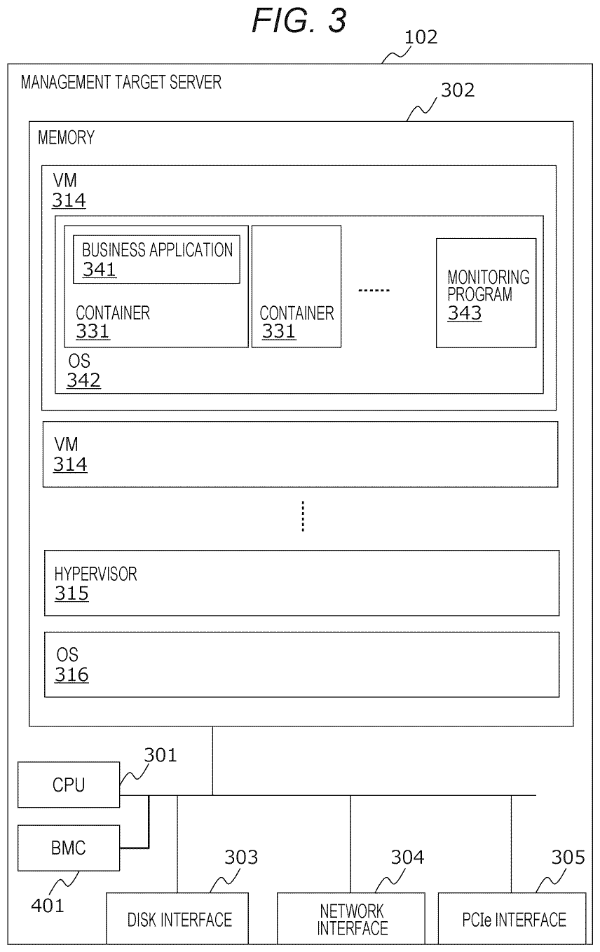

FIG. 3 is a diagram illustrating an example of the structure of a management target server according to the present embodiment.

The management target server 102 includes a disk interface 303, a network interface 304, a PCIe interface 305, a memory 302, and a CPU 301 connected to them. The interfaces 303 to 305 have the same functions as those of the respective interfaces 203 to 205.

The memory 302 stores an OS 316 and a hypervisor 315.

The hypervisor 315 controls generation, activation, termination, and deletion of a VM 314.

The VM 314 executes a business application 341, an OS (for example, a guest OS) 331, and a monitoring program 343. The monitoring program 343 monitors the statuses of components such as the business application 341 and the OS 331, and outputs a log message indicating the statuses. The VM 314 transmits, to the management system 101, a log file containing the outputted log message as an event notification, and system information (information about the structures, performance, failures, and the like) about the internal devices (the CPU 301, the memory 302, the disk interface 303, the network interface 304, the PCIe interface 305, and the like) in the management target server 102, as an event notification.

The management target server 102 may be divided into a plurality of subsystems by LPAR (Logical Partitioning). Further, the management target server 102 may be divided corresponding to the VMs or the insides thereof may be divided by a container technology. Those including the plurality of subsystems may be monitored.

### General Outline of Processes in the Semantic Change Detection System

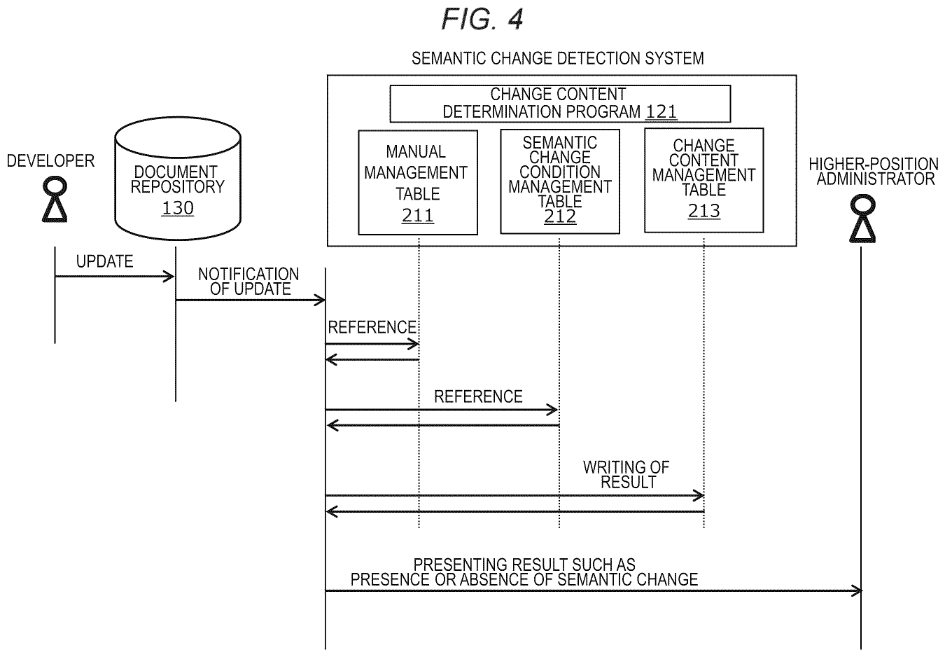

With reference to FIG. 4, there will be described a general outline of processes in the semantic change detection system according to the present embodiment.

FIG. 4 is a diagram illustrating a general outline of processes in the semantic change detection system according to the present embodiment.

In the present embodiment, at timing when a developer has updated a document in the document repository 130, the document repository 130 notifies the semantic change detection system that the document has been updated.

When the semantic change detection system has received this notification, the change content determination program 121 refers to the document management table 211 to determine whether the updated document is a document used in the service system. If so, the change content determination program 121 acquires the updated portions and the contents of the updates (information about the portions before and after the updating, which will be also referred to as update information, hereinafter) and registers them in the change content management table 213.

Using, as inputs, the update information (stored in the document management table 211 and the change content management table 213) about the document, the semantic change detection system causes the change content determination program 121 to generate a prompt to be inputted to a generative AI, by referring to the semantic change condition management table 212. The prompt to be inputted to the generative AI is generated in two stages. This will be described later in detail.

When an answer (presence or absence of a semantic change) has been obtained from the generative AI, the semantic change detection system presents this answer to the higher-position administrator.

### Structures of the Respective Tables

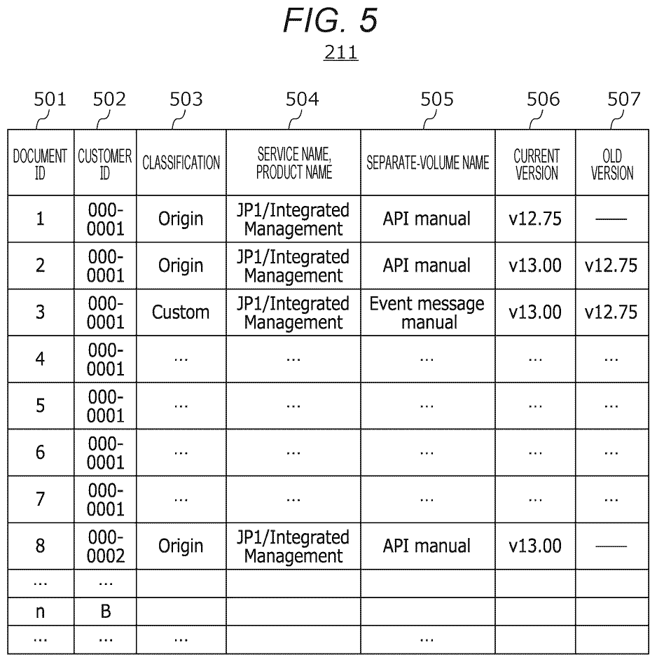

Next, the structures of the respective tables will be described with reference to FIGS. 5 to 7.

FIG. 5 is a diagram illustrating an example of the document management table according to the present embodiment.

The document management table 211 manages information about documents relating to updates. The document management table 211 includes, in correspondence with a document ID 501, a customer ID 502 identifying a service system, a classification 503 for storing presence or absence of a difference from a document repository 130 of a developer, a service name and a product name 504 used in the service system, a separate-volume name 505 for storing a name of the document corresponding to the service or the product, a current version 506 for storing the version of the document ID before updating, an old version 507 for storing the version thereof after updating, and the like.

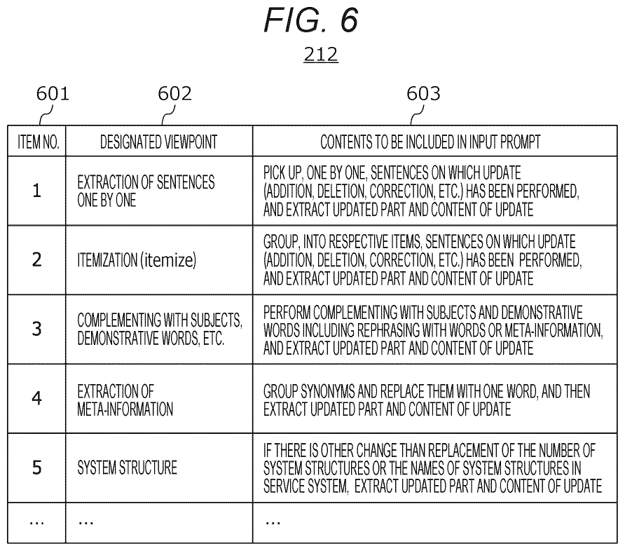

FIG. 6 is a diagram illustrating an example of the semantic change condition management table according to the present embodiment.

The semantic change condition management table 212 is for managing conditions for determining whether or not updates involve semantic changes. In the present embodiment, the determination conditions are organized with designated viewpoints 602. In the present example, as preconditions for detecting semantic changes, there are listed the following viewpoints: (a) one or more sentences are added in the update information, (b) sentences are itemized in the update information, (c) items are changed in the update information, (d) a subject or a verb is included in the update information, and (e) a feature of a preliminarily-defined sentence (specific to the field or the system) is changed in the update information, and the like. The designated viewpoints 602 for input prompts may be set to be implemented in stages, in order to improve the detection accuracy.

In FIG. 6, a reference numeral of 603 illustrates an example of contents included in input prompts reflecting conditions for detecting semantic changes from the designated viewpoint 602. The generative AI generates an output in such a way as to respond to these contents.

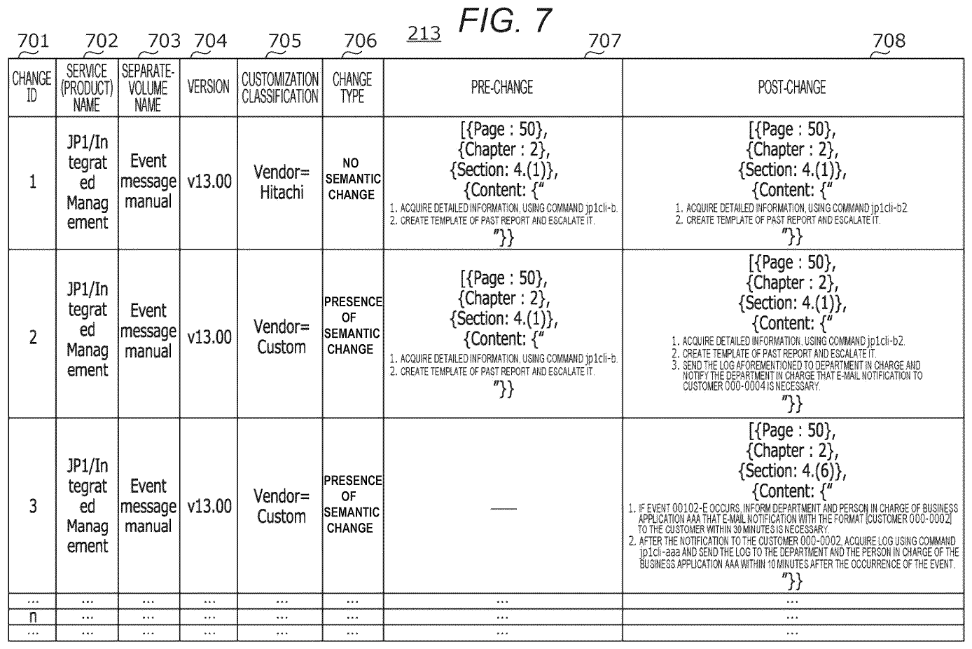

FIG. 7 is a diagram illustrating an example of the change content management table according to the present embodiment.

The change content management table 213 is for managing information updated at timing of updating in the document repository 130 or changing of the service system structure, and includes a change ID 701 and a service (product) name 702 for identifying a changed subject, a separate-volume name 703 for storing each document name, a version 704 for storing the version of the document, a customization classification 705 for classifying whether to use a document provided by a servicer or a document with custom modifications, a change type 706 indicating presence or absence of a semantic change, a pre-change 707 and a post-change 708 for storing contents before and after the update or the change.

Here, the pre-change 707 and the post-change 708 may be acquired through the version management program for the document repository 130, or may be acquired through differential extraction using a text-based generative AI. Such a text-based generative AI divides sentences through a morphological analysis, and extracts changed portions through pattern matching. Thus, for example, such a text-based generative AI may bring the results of extractions into a belt form and may search words distant from each other and words in sentences distant from each other, thereby extracting the changed portions.

### Processes of the Change Content Determination Program

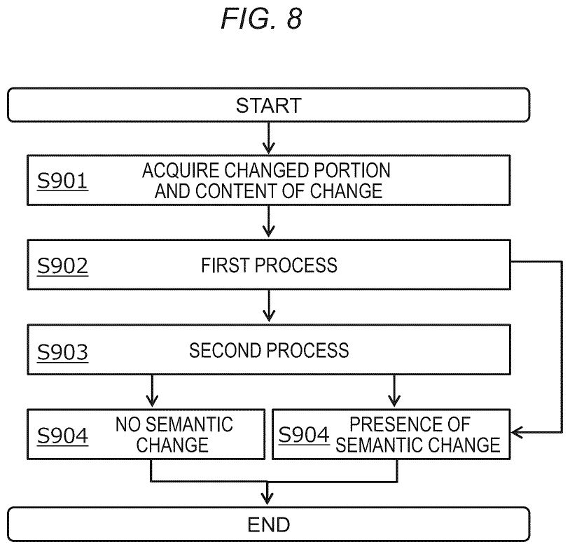

The processes of the change content determination program will be described with reference to FIG. 8.

FIG. 8 is a diagram illustrating an example of processes of the change content determination program according to the present embodiment. The processes are roughly divided into four steps S901 to S904. Hereinafter, the contents of the respective steps will be described.

The step S901 is a step of acquiring update information about a document from the document repository 130. On receiving a notification that a document in the document repository 130 has been updated by a developer through Webhook, the change content determination program 121 accesses the document repository 130 from which the Webhook has been transmitted, acquires update information therefrom, and updates the current version 506 (version 704) and the old version 507 corresponding to the document ID in the document management table 211. In addition, the change content determination program 121 adds a change ID 701 to the change content management table 213, and stores respective values in the service (product) name 702, the separate-volume name 703, the version 704, the pre-change 707, and the post-change 708.

The step S902 is a step of performing a first process for detecting whether the update information includes a semantic change. The change content determination program 121 refers to the semantic change condition management table 212 and creates a prompt to be inputted to the generative AI.

In the present embodiment, along with the input prompt created with reference to the semantic change condition management table 212, an inquiry is made to the generative AI in such a way as to focus on three items of “the subject of manipulations”, “the object to be manipulated”, and “the contents and operations to be manipulated”. For example, a prompt describing “please answer whether or not an update has been performed regarding the subject of manipulations, the object to be manipulated, and the contents and operations to be manipulated, and the reason therefor” is inputted thereto.

Regarding matters which can be determined to include a semantic change at this time, among the matters found to have been “updated” through the answer of the generative AI in the first process, “presence of a semantic change” is registered in the change type 706 in the change content management table 213. For example, if it can be determined that the update information includes “one or more sentences are added” (see the item number 1 of a designated viewpoint in FIG. 6) or “sentences are itemized” (see the item number 2 of a designated viewpoint in FIG. 6) by the answer of the generative AI, this matter is extremely likely to involve a semantic change. Therefore, it is possible to determine “presence of a semantic change” therein without performing further analyses.

On the other hand, regarding matters which can not yet be determined so, among the matters found to have been “updated”, the process proceeds to S903.

The step S903 is a step of performing a second process for detecting whether or not the update information includes a semantic change. The change content determination program 121 generates an input prompt for further deeply examining matters that can not be determined by the first process, among the matters found to have been “updated”. This input prompt is specified such that a domain knowledge is to be used. The domain knowledge is prepared, for example, as specific information deeply related to the service system targeted by the updated document, and includes relationships between synonyms, abbreviations, wordings, and upper/lower hierarchical relationships between terms in the field of the service system and, in addition, basic system structures, technical common knowledge, and the like. In the second process, the generative AI generates meta information from the update information, by referring to the domain knowledge, in accordance with the input prompt, and detects the presence or absence of a semantic change at a meta-information level.

For example, a retrieval-augmented generation (RAG) can be structured using a generative AI, in order to enable hybrid search (character string search or vector search) for information about documents and hardware/software used in the targeted service system and system structures of the service system. This raises expectation for improvement of the accuracy of extraction of meta information and detection of the presence or absence of a change in the meta information.

Next, there will be described examples of determinations at the meta information level.

Regarding “the subject of manipulations”, as an example, the determination of presence or absence of a semantic change is performed, by generating synonyms as meta information using the domain knowledge. For example, a change from “an operator is . . . ” to “a maintenance staff is . . . ”, a change from “an Operator is . . . ” to “a L1 Operator is . . . ”, a change from “jp1im-cmd-A-R . . . ” to “jp1im3-cmd-A-R . . . ” are determined not to involve a semantic change at the meta-information level. On the other hand, a change from “a manager is . . . ” to “a leader of an operator team is . . . ” is determined to involve a semantic change at the meta-information level.

Next, regarding “the object to be manipulated”, as an example, the determination of presence or absence of a semantic change is performed, by generating meta information about the structure of the targeted service system using the domain knowledge. For example, a change from “restart-name server-app_01” to “restart-name server-app_01 server-app_02” is a change for adding the command “server-app_02” in the event of scale out of the server of the management target system. This change can be determined not to involve a semantic change, at the meta information level, through the domain knowledge about the service system. On the other hand, a change from “stop-name server-app_ 01” to “stop-service db app” is a change from “specification of a single server” to “specification of a database server, an application server, and a service”. This change is determined to include a semantic change at the meta-information level.

Further, regarding the contents and operations to be manipulated, as an example, the determination as to whether or not a change has occurred is performed, by generating meta information about replacements of terms and wordings using the domain knowledge. In a case of replacement of a command name or an API name, it is determined that this replacement includes a semantic change at the meta-information level. For coping therewith, Readme.txt can be incorporated into the RAG, and a prompt can be generated using information about an API deprecated in version specification and a succeeding API. In this manner, documents about hardware and software constituting the service system, and services thereof may be incorporated into the RAG. On the other hand, a change of a recommended way of use, and a change of information about an increase or decrease of options from those in the aforementioned information will involve semantic changes at the meta-information level.

The step S904 is a step of outputting whether or not the update information includes a semantic change. The change content determination program 121 stores the information about the presence or absence of a semantic change, in the change content management table 213, and presents this information to the higher-position administrator terminal 180.

The processing steps described above are merely an example, and the number of steps for detecting whether or not update information includes a semantic change is not limited to two, and may be one or three or more. The designated viewpoints for the determination in each step may be appropriately set according to the field and the contents of the business, the contents of documents, and the like.

### EXAMPLES OF MODIFICATIONS

Although the embodiment of the present invention has been described above, the present invention is not limited to the above-described embodiment, and various modifications can be made thereto without departing from the gist of the present invention.

For example, although, in the present embodiment, the change content determination program 121 uses a generative AI for detecting semantic changes in update information, the present invention is not limited thereto, and may use other inferring means such as a rule-based system.

Furthermore, in the present embodiment, the change content determination program 121 refers to the semantic change condition management table 212 when creating a prompt to be inputted to the generative AI in the first process. However, in addition thereto, the change content determination program 121 may provide information about a skill and the division of the user (higher-position administrator) to the generative AI. For example, by providing the information about that the user (higher-position administrator) is a “system management administrator”, it is possible to clarify the background of the inquiry, thereby raising expectation for improvement in the accuracy of the answer.

Furthermore, although, in the present embodiment, documents and the document repository 130 to be managed by the management system 101 are in the management target system 100 or a server included therein, the present invention is not limited thereto, and the documents and the document repository 130 may be in an ordinary information device.

Further, the present invention also includes the following aspects.

### Aspect 1

A semantic change detection system for detecting whether or not an updated portion of a document related to a service system includes a semantic change, the semantic change detection system including:
an update acquisition unit adapted to acquire the updated portion;
a first processing unit, the first processing unit being adapted to detect whether the updated portion acquired by the update acquisition unit includes a semantic change, the first processing unit being further adapted to present, to a user, that the updated portion includes the semantic change when the first processing unit detects that the updated portion includes the semantic change; and
a second processing unit, the second processing unit being adapted to detect whether or not the updated portion not having been detected to include the semantic change by the first processing unit includes the semantic change at a meta-information level, by generating meta information using domain knowledge relating to the service system, the second processing unit further being adapted to present, to the user, a result of the detection for the updated portion.

### Aspect 2

The semantic change detection system according to aspect 1, wherein the first processing unit detects whether the updated portion includes the semantic change, based on whether or not a subject that manipulates the service system, an object to be manipulated, or a content or an operation to be manipulated has been updated.

### Aspect 3

The semantic change detection system according to aspect 1 or 2, further including a semantic change condition management unit adapted to manage a condition regarding the semantic change,
wherein the detections by the first processing unit and the second processing unit are based on the condition managed by the semantic change condition management unit.

### Aspect 4

The semantic change detection system according to aspect 3, wherein the first processing unit and the second processing unit include a generative AI, and
a prompt to be inputted to the generative AI is created based on the condition in the semantic change condition management unit.

### Aspect 5

The semantic change detection system according to aspect 4, wherein information about a skill or division of the user is also inputted to the generative AI in the first processing unit.

What is claimed is:

1. A semantic change detection system for detecting whether or not an updated portion of a document related to a service system includes a semantic change, the semantic change detection system comprising:
an update acquisition unit adapted to acquire the updated portion;
a first processing unit, the first processing unit being adapted to detect whether the updated portion acquired by the update acquisition unit includes a semantic change, the first processing unit being further adapted to present, to a user, that the updated portion includes the semantic change when the first processing unit detects that the updated portion includes the semantic change; and
a second processing unit, the second processing unit being adapted to detect whether or not the updated portion not having been detected to include the semantic change by the first processing unit includes the semantic change at a meta-information level, by generating meta information using domain knowledge relating to the service system, the second processing unit further being adapted to present, to the user, a result of the detection for the updated portion.

2. The semantic change detection system according to claim 1, wherein
the first processing unit detects whether the updated portion includes the semantic change, based on whether or not a subject that manipulates the service system, an object to be manipulated, or a content or an operation to be manipulated has been updated.

3. The semantic change detection system according to claim 2, further comprising
a semantic change condition management unit adapted to manage a condition regarding the semantic change,
wherein the detections by the first processing unit and the second processing unit are based on the condition managed by the semantic change condition management unit.

4. The semantic change detection system according to claim 3, wherein
the first processing unit and the second processing unit include a generative AI, and
a prompt to be inputted to the generative AI is created based on the condition in the semantic change condition management unit.

5. The semantic change detection system according to claim 4, wherein
information about a skill or division of the user is also inputted to the generative AI in the first processing unit.
